(19) United States
(12) Patent Application Publication
(10) Pub. No.: US 2026/0053176 A1
(43) Pub. Date: Feb. 26, 2026

(54) A PROCESS FOR PRODUCING A WET SAVOURY PRODUCT

(71) Applicant: SOCIETE DES PRODUITS NESTLE S.A., Vevey (CH)

(72) Inventors: Tat Wei YAN, Singen (DE); Bernd HARTENBERGER, Tengen-Watterdingen (DE); Elvia Luigina MURGUEYTIO RIOFRÍO, Stockach (DE)

(21) Appl. No.: 19/105,387

(22) PCT Filed: Aug. 14, 2023
(86) PCT No.: PCT/EP2023/072376

§ 371 Date: Feb. 21, 2025

(30) Foreign Application Priority Data
Aug. 31, 2022 (EP) 22193070.4

(51) Int. Cl. A23L 23/10; A23L 29/10; A23L 29/212

(52) U.S. Cl. CPC A23L 23/10; A23L 29/10; A23L 29/212

(57) ABSTRACT

The invention relates to a process for producing a wet savoury product. In particularly the invention relates to a process for producing a wet savoury product comprising the step of mixing a composition comprising water, oil, soluble fiber having a molecular weight below 6000 g/mol and flavor, pasteurize the mixture and after cooling adding an un-gelatinized starch followed by packaging the wet savoury product.

### TECHNICAL FIELD

The invention relates to a process for producing a wet savoury product. In particularly the invention relates to a process for producing a wet savoury product comprising the step of mixing a composition comprising water, oil, soluble fiber having a molecular weight below 6000 g/mol and flavor, pasteurize the mixture and after cooling adding an un-gelatinized starch followed by packaging the wet savoury product.

### BACKGROUND

It is known to mix all dry ingredients including starch with water and oil followed by a heating step to pasteurize the mixture and cooling it afterwards before packaging. Due to the heating step the un-gelatinized starch is gelatinizing. Alpha amylase enzyme carried over by ingredients into the recipes is known to be able to act on gelatinized starch, causing liquification and thinning of wet culinary products over shelf-life. It is known that pH<4.5 can significantly decrease activity of alpha amylase enzyme in the recipes and therefore control of the pH is essential. In addition, to ensure microbiological safe and stable products acidity is also used to ensure a desired water activity of the wet savoury product. Products with this pH will have a sour taste profile that is unfavorable in certain recipes, such as mushroom, pumpkin, and bechamel sauce. Addition of sweetness (e.g., sugar, honey, caramelized onion) or cream are usually the solutions to mask the sourness, however they do impact negatively the Nutri-Score of the product.

In order to achieve wet savoury products, a consumer-friendly solution ingredient is needed to help lowering the water activity, while providing practical steps to sufficiently control liquification in starch containing recipes. In addition, less acidity might be preferred in certain recipes.

### SUMMARY OF THE INVENTION

The object of the present invention is to improve the state of the art or at least provide an alternative for a process for the production of a wet savoury product:
i) ensure microbiological safe and stable products;
ii) water activity is below 0.900;
iii) very limited or no starch degradation;
iv) consumer friendly labelling;
v) avoiding chemical preservatives;
vi) good taste and mouthfeel;
vii) reach a shelf life over 9 months with the same or better sensory properties;
viii) provide good mixing properties;
ix) the process provides a good machinability especially regarding filling of packaging;
x) ensure easy re-movement of the wet savoury product out of the packaging.

The object of the present invention is achieved by the subject matter of the independent claims. The dependent claims further develop the idea of the present invention.

Accordingly, the present invention provides in a first aspect a process for producing a wet savoury product comprising the steps of:
a) mixing a composition comprising 15 to 60 wt % water based on the total wet savoury product, 0 to 25 wt % oil based on the total wet savoury product, 4 to 30 wt % soluble fiber based on the total wet savoury product and 5 to 65 wt % of flavors based on the total wet savoury product;
b) pasteurizing the mix of step a);
c) cooling the pasteurized mix below the gelatinating temperature of the un-gelatinized starch;
d) adding 0.5 to 20 wt % of un-gelatinized starch based on the total wet savoury product and mixing further;
e) packaging the wet savoury product;
   wherein the soluble fiber has a molecular weight below 6000 g/mol and wherein the wet savoury product is not a gel.

It has been surprisingly found by the inventors that a process for the production of a wet savoury product comprising soluble fiber having a molecular weight below 6000 g/mol have the necessary attributes:
water activity can be lowered to ensure a microbiological safe and stable product;
reach a shelf life over 9 months with the same or better sensory properties;
very limited or no starch degradation as the starch is not gelatinized;
good taste and mouthfeel especially more creamy and less acidic taste;
consumer friendly labelling and avoiding chemical preservatives;
the process provides a good machinability especially regarding filling of packaging;
ensure easy re-movement of the wet savoury product out of the packaging;

### DETAILED DESCRIPTION

The present invention pertains to a process producing a wet savoury product comprising the steps of:
f) mixing a composition comprising 15 to 60 wt % water based on the total wet savoury product, 0 to 25 wt % oil based on the total wet savoury product, 4 to 30 wt % soluble fiber based on the total wet savoury product and 5 to 65 wt % of flavors based on the total wet savoury product;
g) pasteurizing the mix of step a);
h) cooling the pasteurized mix below the gelatinating temperature of the un-gelatinized starch;
i) adding 0.5 to 20 wt % of un-gelatinized starch based on the total wet savoury product and mixing further;
j) packaging the wet savoury product;
   wherein the soluble fiber has a molecular weight below 6000 g/mol and wherein the wet savoury product is not a gel.

In a preferred embodiment the present invention pertains to a process producing a wet savoury product comprising the steps of:
a) mixing a composition comprising 15 to 45 wt % water based on the total wet savoury product, 5 to 25 wt % oil based on the total wet savoury product, 4 to 30 wt % soluble fiber based on the total wet savoury product and 5 to 60 wt % of flavors based on the total wet savoury product;
   b) pasteurizing the mix of step a);
   c) cooling the pasteurized mix below the gelatinating temperature of the un-gelatinized starch;
   d) adding 3 to 20 wt % of un-gelatinized starch based on the total wet savoury product and mixing further;
   e) packaging the wet savoury product;
      wherein the soluble fiber has a molecular weight below 6000 g/mol and wherein the wet savoury product is not a gel.

“Wet savoury product” means a product having a total solid content between 30 to 75 wt % (based on the total wet savoury product). A wet savoury product is not a dehydrated product. A wet savoury product is a paste. Savoury means a salty and/or spicy product. The wet savoury product is a soup concentrate or a sauce, preferably a soup concentrate. A concentrate means that the product is a paste. The concentrate needs to be diluted with water by the consumer before cooking.

“Gel” means a solid or semi-solid material that come out of packaging as one piece. Once removed from the packaging, it does not follow on a time scale of a few minutes.

“Paste” means the mass of the composition change its shape against gravity on time scale of a less than one minute.

The wet savoury product comprises water in an amount between 15 to 60 wt % (based on the total wet savoury product), preferably between 15 to 45 wt %, preferably between 15 to 40 wt %, preferably between 15 to 35 wt %, preferably between 20 to 45 wt %, preferably between 20 to 40 wt %, preferably between 20 to 35 wt %, preferably between 20 to 30 wt % (based on the total wet savoury product).

The wet savoury product comprises oil in an amount between 0 to 25 wt % (based on the total wet savoury product), preferably between 5 to 25 wt %, preferably between 5 to 20 wt %, preferably between 5 to 15 wt % (based on the total wet savoury product). In an embodiment, the oil is a vegetable oil. Preferably, the oil is selected from the group consisting of sunflower oil, rape seed oil, cotton seed oil, peanut oil, soya oil, olive oil, coconut oil, algal oil, safflower oil, corn oil, rice bran oil, sesame oil, hazelnut oil, avocado oil, almond oil, walnut oil or a combination thereof; more preferably sunflower oil. The term sunflower oil includes also high oleic sunflower oil. In the context of the present invention the term “oil” refers to triglycerides which are liquid or pourable at a room temperature of 20° C., for example liquid or pourable at a room temperature of 25° C. The oil has a solid fat content of less than 10% at 20° C., preferably less than 5% at 20° C., preferably less than 2% at 20° C., preferably 0% at 20° C. The oil may be rich in monounsaturated and polyunsaturated fatty acids.

“Soluble fiber” means a water-soluble dietary fiber, which dissolve in water. In an embodiment the soluble fiber has a molecular weight below 6000 g/mol, preferably below 4000 g/mol, preferably below 2000 g/mol, preferably below 1000 g/mol, preferably between 100 to 6000 g/mol, preferably between 100 to 4000 g/mol, preferably between 400 to 4000 g/mol, preferably between 400 to 2000 g/mol, preferably between 400 to 1000 g/mol. In a preferred embodiment the soluble fiber is selected from the group of chicory root fiber, corn fiber, sugar beet fiber or a combination thereof. In a more preferred embodiment, the soluble fiber is selected from the group of chicory root fiber. In a preferred embodiment the soluble fiber is selected from the group of chicory root fiber, corn fiber, sugar beet fiber or a combination thereof having a molecular weight below 6000 g/mol, preferably below 4000 g/mol, preferably below 2000 g/mol, preferably below 1000 g/mol, preferably between 100 to 6000 g/mol, preferably between 100 to 4000 g/mol, preferably between 400 to 4000 g/mol, preferably between 400 to 2000 g/mol, preferably between 400 to 1000 g/mol. In a more preferred embodiment, the soluble fiber is selected from the group of chicory root fiber having a molecular weight between 1000 to 2000 g/mol.

The chicory root fiber has a molecular weight of 1440 g/mol. The corn fiber has a molecular weight between 500-900 g/mol. The sugar beet fiber has a molecular weight of 600 g/mol. The following soluble fibers are excluded from the present invention as having a molecular weight above 6000 g/mol selected from the group of guar gum (50000 g/mol), pectin (165000 g/mol), beta glucans of rye (21000 g/mol), beta glucans of barley (31000 g/mol), beta glucans of oat (65000 g/mol), beta glucans of wheat (487000 g/mol) or a combination thereof. In a preferred embodiment the wet savoury product does not include soluble fibers having a molecular weight above 6000 g/mol. In a preferred embodiment the wet savoury product does not include soluble fibers selected from the group of guar gum, pectin, beta glucans of rice, beta glucans of barley, beta glucans of oat, beta glucans of wheat or a combination thereof. The advantage of soluble fibers having a molecular weight below 6000 g/mol allows more molecule per same weight having a higher capacity to hold water, hence a higher water activity depression effect. Take guar gum with average 50000 molecular weight will need 34.7× more volume of guar gum compared to chicory root fiber from Orafti to deliver the same water activity depression effect. In a preferred embodiment the wet savoury product does not include water insoluble fibers for example citrus fiber.

The wet savoury product comprises soluble fiber in an amount between 4 to 30 wt % (based on the total wet savoury product), preferably between 4 to 25 wt %, preferably between 4 to 20 wt % (based on the total wet savoury product).

The wet savoury product comprises flavor in an amount between 5 to 65 wt % (based on the total wet savoury product), preferably between 5 to 60 wt %, preferably between 10 to 65 wt %, preferably between 10 to 60 wt %, preferably between 5 to 55 wt %, preferably between 10 to 55 wt %, preferably between 5 to 50 wt %, preferably between 10 to 50 wt %, preferably between 5 to 45 wt %, preferably between 10 to 45 wt %, preferably between 15 to 60 wt %, preferably between 15 to 55 wt %, preferably between 15 to 50 wt %, preferably between 15 to 45 wt %, preferably between 20 to 60 wt %, preferably between 20 to 55 wt %, preferably between 20 to 50 wt %, preferably between 20 to 45 wt % (based on the total wet savoury product). The term “flavor” in the context of this invention includes salt, sugar, acids, taste enhancing ingredients, herbs, spices, vegetables or mixtures thereof, which are suitable for being used in a food product. Taste enhancing ingredients may be provided by monosodium glutamate (MSG), yeast extract, hydrolysed plant protein, bacterial extract, vegetable extract or a combination thereof. A bacterial extract is described within WO2009040150 or WO2010105842. A vegetable extract is described within WO2013092296. Salt refers to any suitable alkali metal salt or mixture thereof. The salt used in the composition of this invention is typically, but not limited to, sodium chloride. For example, potassium chloride may be used or any low-sodium product having a taste impression of sodium chloride may be used, as long as the taste in the end formulation is acceptable. Acids may be provided by vinegar, lactic acid, citric acid or combination thereof.

In an embodiment the herbs, spices and vegetables are selected from the group consisting of parsley, celery, fenugreek, lovage, rosemary, marjoram, dill, tarragon, coriander, leek, ginger, lemongrass, curcuma, chili, ginger, paprika, carrot, mustard, garlic, onion, shallots, turmeric, tomato, oregano, thyme, basil, chilies, paprika, mushrooms, pimento, jalapeno pepper, white pepper, black pepper or a combination thereof.

After pasteurization and before adding the un-gelatinzed starch the pasteurized mixture is cooled to a temperature between 25 to 65° C., preferably to a temperature between 25 to 60° C., preferably to a temperature between 25 to 55° C., preferably to a temperature between 25 to 50° C., preferably to a temperature between 25 to 45° C., preferably to a temperature between 30 to 50° C., preferably to a temperature between 35 to 45° C.

The wet savoury product comprises un-gelatinized starch in an amount between 0.5 to 20 wt % (based on the total wet savoury product), preferably between 3 to 20 wt %, preferably between 3 to 15 wt %, preferably between 3 to 12 wt %, preferably between 5 to 15 wt % (based on the total wet savoury product).

The term “un-gelatinized starch” refers to starch that is in an un-swollen, semi-crystalline state. Due to birefringence, it presents maltese crosses when examined under the microscope with polarized light. During cooking the starch loses the birefringence, starts to absorb water which results in swelling of the starch granules and product thickening. The starch or mixtures of starches are selected among starches that have a rather high gelatinization temperature such as corn starch, chemically modified starches, physically modified starches such as annealed or heat-moisture treated starch as potato starch, preferably potato starch, corn starch or a combination thereof. Flours can also be used as a source of starch. The un-gelatinised starch must remain in an un-swollen, semi-crystalline state during preparation of the composition. This is so that the thickening function of the starch is preserved until such time as a user or a consumer at home cooks it for a few minutes. The ungelatinized starch then gelatinises to provide the desired thickening to the soup, sauce or gravy. The un-gelatinised starch used for the preparation of the wet savoury product can be selected according to a specific gelatinisation/pasting profile so that it can be incorporated into the composition at a temperature below the gelatinizing (or swelling) temperature.

In an embodiment, the wet savoury product of the present invention further comprises an emulsifier. The term “emulsifier” is selected from the group consisting of egg yolk, lecithin, mustard, soy lecithin, sodium phospates, sodium stearoyl lactylate, diacetyl tartaric ester of monoglyceride (DATEM), polyglycerol-polyricinoleate (PGPR), monoglyceride and mono-diglyceride, proteins or combinations thereof, preferably proteins. The term “protein” is selected from the group consisting of milk, whey protein, soy protein, pea protein, caseinate, egg albumen, lyzozyme, gluten, rice protein, corn protein, potato protein, skimmed milk proteins or any kind of globular and random coil proteins as well as combinations thereof, preferably wheat protein, soy protein, pea protein of a combination thereof. The wet savoury product comprises emulsfier in an amount between 0 to 10 wt % (based on the total wet savoury product), preferably between 1 to 10 wt %, preferably between 3 to 10 wt %, preferably between 3 to 8 wt % (based on the total wet savoury product). The wet savoury product comprises protein in an amount between 0 to 10 wt % (based on the total wet savoury product), preferably between 1 to 10 wt %, preferably between 3 to 10 wt %, preferably between 3 to 8 wt % (based on the total wet savoury product).

In an embodiment the wet savoury product has a water activity of below 0.9, preferably between 0.8 to 0.90, preferably between 0.82 to 0.90, preferably between 0.85 to 0.90. Water activity was measured with Hygrolab HC2-aw-USB (Rotronic AG, Switzerland) connected to PC with HW4-P-QUICK-Vx software (Rotronic AG, Switzerland). Measurement were carried out at 25.0±0.5° C. according to AOAC 978.18-1978, Water activity of canned vegetables.

### Examples

### Example 1: Process

All ingredients (water, oil, soluble fiber and flavor) except starch have been mixed. The mixture was heated to a temperature of 72° C. for at least 2 min to pasteurize the mixture. After cooling to 40° C. un-gelatinized starch has been added and further mixed. The whole composition has been packed in pouches.

### Examples 2 to 3: Mushroom soup

Comp. example 2 and example 3 have been prepared according to example 1.

| Composition | Comp. Example 2 | Example 3 |
|---|---|---|
| Water [wt %] | 26 | 27.7 |
| Oil [wt %] | 16.8 | 11.2 |
| Soluble fiber (chicory root | — | 16.8 |
| fiber Orafti oligofructose) | | |
| [wt %] | | |
| Vinegar [wt %] | 6 | — |
| Flavor [wt %] | 41.2 | 34.3 |
| Native potato starch [wt %] | 10 | 10 |
| aw | 0.902 | 0.867 |
| pH | 4.85 | 5.55 |

In comparison example 1 without adding soluble fiber the water activity is higher than 0.900 despite the fact that vinegar was added. The soup paste of example 2 is flowing better for packaging reason and it is easy to squeeze the product out of the pouch. The water activity of example 2 is 0.867 and therefore shelf stable. No starch degradation has been observed after 2 months shelf-life.

8 internal experienced panelists were used to rate the taste and mouthfeel of comparison example 2 and example 3. All of them rated example 3 as having no acidic off-taste and in addition as delivering a creamy mouthfeel, despite the fact that example 3 has no added cream or milk ingredient. Comparison example 2 has been perceived as having an acidic off-taste and not the creamy mouthfeel as example 3.

### Examples 4 to 7: Chicken vegetable curry soup

Coin. examples 4, example 5 and comp. examples 6 to 7 have been prepared according to example 1.

| | Comp. | | Comp. | Comp. |
|---|---|---|---|---|
| Composition | Example 4 | Example 5 | example 6 | example 7 |
| Water [wt %] | 25.4 | 24.4 | 24.4 | 24.4 |
| Oil [wt %] | 5.7 | 10.5 | 10.5 | 10.5 |
| Soluble fiber (corn | — | 9.9 | — | — |
| fiber from Promitor) | | | | |
| [wt %] having a | | | | |
| molecular weight | | | | |
| between 500- | | | | |
| 900 g/mol | | | | |
| Soluble fiber | — | — | 9.90 | — |
| (acacia gum) | | | | |
| having a molecular | | | | |
| weight of | | | | |
| 250000 g/mol | | | | |
| Insoluble fiber | — | — | — | 9.90 |
| (wheat bran) | | | | |
| Vinegar [wt %] | 5.5 | 5.2 | 5.2 | 5.2 |
| Flavor [wt %] | 53.4 | 40 | 40 | 40 |
| Waxy corn starch | 10 | 10 | 10 | 10 |
| [wt %] | | | | |
| aw | 0.915 | 0.892 | 0.912 | 0.915 |
| pH | 4.43 | 4.57 | 4.57 | 4.57 |

Chicken Vegetable Curry Soup has sourness as part of the taste profile, so vinegar has been used in both examples. Nevertheless, in example 5 it is shown that soluble fiber having a molecular weight below 6000 g/mol is depressing the water activity to achieve a shelf stable product. No starch degradation has been observed after 2 months shelf-life. Comp. example 6 use a soluble fiber having a molecular weight above 6000 g/mo (acacia gum) and it is shown that the water activity is not depressed and higher as shown for example 5. Using an insoluble fiber as shown in comp. example 7 is also not depressing the water activity.

### Examples 8 to 9: Bechamel sauce

Examples 8 to 9 have been prepared according to example 1.

| Composition | Example 8 | Example 9 |
|---|---|---|
| Water [wt %] | 33.1 | 30.2 |
| Oil [wt %] | 13 | 13 |
| Soluble fiber (chicory | 6.4 | 11 |
| root fiber Orafti | | |
| oligofructose) [wt %] | | |
| Flavor (mainly | 42.5 | 40.8 |
| skimmed milk powder) | | |
| [wt %] | | |
| Native potato starch | 5 | 5 |
| [wt %] | | |
| aw | 0.887 | 0.882 |
| pH | 5.39 | 5.52 |

### Comp. Example 10: Comparison to Standard Process

The standard process has been to mix all ingredients including the starch. The mixture was heated to a temperature of 72° C. for at least 2 min to pasteurize the mixture. The whole composition has been packed in pouches. For this comparison process the composition of comparison example 2 has been used.

Due to the gelatinization of starch through the pasteurization step the viscosity of the wet savoury product is increased, which makes it more difficult to fill the pouch and also to remove the wet savoury product out of the pouch (squeezing of pouch). In addition, 8 internal experienced panelists preferred the cooking experience of comparison example 2 and example 3 compared to comparison example 10. One pouch of the wet savoury product has been added in 500 ml water and heated until boiling. In comparison example 2 and example 3 the final texture of the soup has been developed during heating as the un-gelatinized starch is gelatinizing. Comparison example 10 does not give this cooking experience as the already gelatinized starch is only diluted in water.

1. A process for producing a wet savoury product comprising the steps of:
a) mixing a composition comprising 15 to 60 wt % water based on the total wet savoury product, 0 to 25 wt % oil based on the total wet savoury product, 4 to 30 wt % soluble fiber based on the total wet savoury product and 5 to 65 wt % of flavors based on the total wet savoury product;
b) pasteurizing the mix of step a);
c) cooling the pasteurized mix below the gelatinating temperature of an un-gelatinized starch;
d) adding 0.5 to 20 wt % of un-gelatinized starch according to step c) based on the total wet savoury product and mixing further;
e) packaging the wet savoury product.
wherein the soluble fiber has a molecular weight below 6000 g/mol and wherein the wet savoury product is not a gel.

2. A process for producing a wet savoury product according to claim 1, wherein the wet savoury product comprises a total solid content between 30 to 75 wt % based on the total wet savoury product.

3. A process for producing a wet savoury product according to claim 1, wherein the composition comprises 15 to 45 wt % water based on the total wet savoury product, 5 to 25 wt % oil based on the total wet savoury product, 4 to 30 wt % soluble fiber based on the total wet savoury product and 5 to 60 wt % of flavors based on the total wet savoury product.

4. A process for producing a wet savoury product according to claim 1, wherein the un-gelatinized starch is present in an amount of 3 to 20 wt % based on the total wet savoury product.

5. A process for producing a wet savoury product according to claim 1, wherein the un-gelatinized starch is selected from the group of corn starch, potato starch or a combination thereof.

6. A process for producing a wet savoury product according to claim 1, wherein the soluble fiber is selected from the group of soluble corn fiber, soluble chicory root fiber, soluble sugar beet fiber or a combination thereof.

7. A process for producing a wet savoury product according to claim 1, wherein the soluble fiber comprises a soluble chicory root fiber having a molecular weight between 1000 to 2000 g/mol.

8. A process for producing a wet savoury product according to claim 1, wherein the pasteurizing in step b) is done at a temperature of at least 70° C.

9. A process for producing a wet savoury product according to claim 1, wherein the mix in step c) is cooled to a temperature between 25 to 65° C.

10. A process for producing a wet savoury product according to claim 1, wherein the un-gelatinized starch is added as a powder or as a water-starch slurry.

11. A process for producing a wet savoury product according to claim 1, wherein the wet savoury product has a water activity between 0.800 to 0.900.

12. A process for producing a wet savoury product according to claim 1, wherein the wet savoury product further comprises an emulsifier.

13. A process for producing a wet savoury product according to claim 1, wherein the wet savoury product is a paste.

14. A process for producing a wet savoury product according to claim 1, wherein the packaging is a pouch.

15. A process for producing a wet savoury product according to claim 1, wherein the wet savoury product is a soup concentrate or a sauce.
